(19) United States
(12) Patent Application Publication
(10) Pub. No.: US 2007/0015577 A1
(43) Pub. Date: Jan. 18, 2007

(54) Joypad with a display unit

(75) Inventor: Wei Hsu, Taipei (TW)

Correspondence Address: Hsu Wei, P.O. Box 44- 2049, Taipei, 10668, TW

(73) Assignee: WEISTECH TECHNOLOGY CO., LTD.

(21) Appl. No.: 11/182,824

(22) Filed: Jul. 18, 2005

(51) Int. Cl. A63F 13/00

(52) U.S. Cl. 463/37

(57) ABSTRACT

A joypad with a display unit comprises a controller and a liquid crystal display to transmit the video and audio signals of the video game console by wire or wireless connection. It could eliminate the playing space limitation such as indoor terrain and features, or avoid the impacts such as the installation position of the video game console or the temporary interference from outside to enhance the flexibility of portable operating and playing and to achieve the son et lumiere and the live feeling.

### BACKGROUND OF THE INVENTION

1. Field of the Invention

This invention relates to a joypad with a display unit which can control and transmit the video and audio signals of the video game console by wire or wireless connection.

2. Description of the Prior Art

Referring to the FIG. 1, the prior known video game console structure comprises a video game console, a game controller, a home television and a matching game disc. A user could enjoy the video and audio presentation through the game processing from the home television, and could react and manipulate the object's movement based on the game scenario to acquire a lot of great fun from passing each critical test.

Normally, most users use video game console on the specific or fixed position (which usually the place of most close to the home television) for allowing the video transmission line to transmit the whole game processes completely. However, this connecting structure limits the user's operation space and playing location which is bound to the home television. It could not allow the user to manipulate the game as his/her free will without any disturbance, especially the user's playing emotion could be interrupted by any sudden interference. Furthermore, there are some specific type videogame players such as hand-held videogames which cost the user a lot of money to purchase and much time to manage these various machines. It is the motivation to invent a new-type joypad with the features of the compatibility to the present video game console and the convenience and the flexibility of the hand-held videogame at the same time.

Therefore, considering the utility inconvenience, this invention is created to increase the value of substantial utility through the continuous tests and prototyping based on inventor's professional knowledge and sensitivity and experience and spirit of pursuing innovation and perfecting.

### SUMMARY OF THE INVENTION

This invention is a joypad combined with a liquid crystal display unit which can control and transmit the video and audio signals to the video game console through wire or wireless connection. The principal objects and also the features of this invention are:
1. To improve the playing space and environment without the limitation of indoor terrain and features;
2. To avoid the temporary interference from outside, especially the other wants to use the home television; and
3. To make the user fully enjoy the son et lumiere and the live feeling immediately.

### BRIEF DESCRIPTION OF THE DRAWINGS

FIG. 1 is a video game console structure view of a prior art;

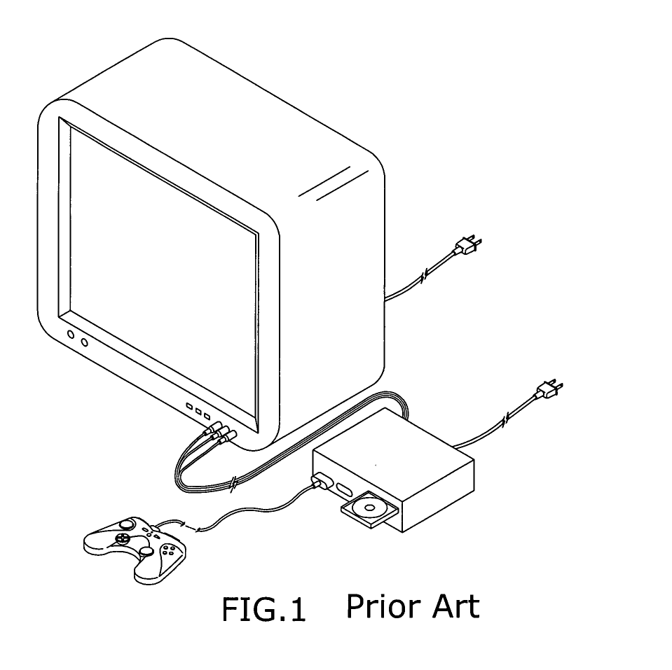

FIG. 2 is a system perspective view of the preferred embodiment of the present invention;

FIG. 3 is a system function block chart of the preferred embodiment of the present invention;

FIG. 4 is an appearance view of the preferred embodiment of the present invention;

FIG. 5 is a lateral appearance view of the preferred embodiment of the present invention;

FIG. 6 is a system perspective view of the second preferred embodiment of the present invention;

FIG. 7 is a system function block chart of the second preferred embodiment of the present invention.

### DESCRIPTION OF THE PREFERRED EMBODIMENTS

This invention comprises a joypad 1 and a video game console 3. For the wire connection embodiment, the joypad 1 connects the video game console 3 through a cable 2 and a video transmission line 4. For the wireless connection embodiment, the joypad 1 connects the video game console 3 through a wireless receiver 5 and a wireless transmitter 6.

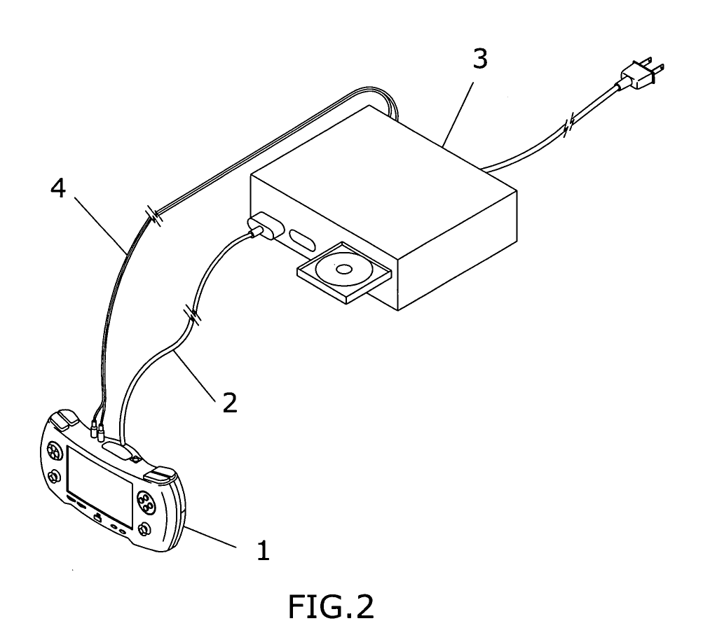

Referring to the FIG. 2, it is a wire connection embodiment of the video game console 3. This wire connection structure comprises the video game console 3, the joypad 1, the cable 2, and the video transmission line 4. Especially, the joypad 1 comprises the combination of a controller 10 and a liquid crystal display 11 together for commanding the video game and for displaying the game images.

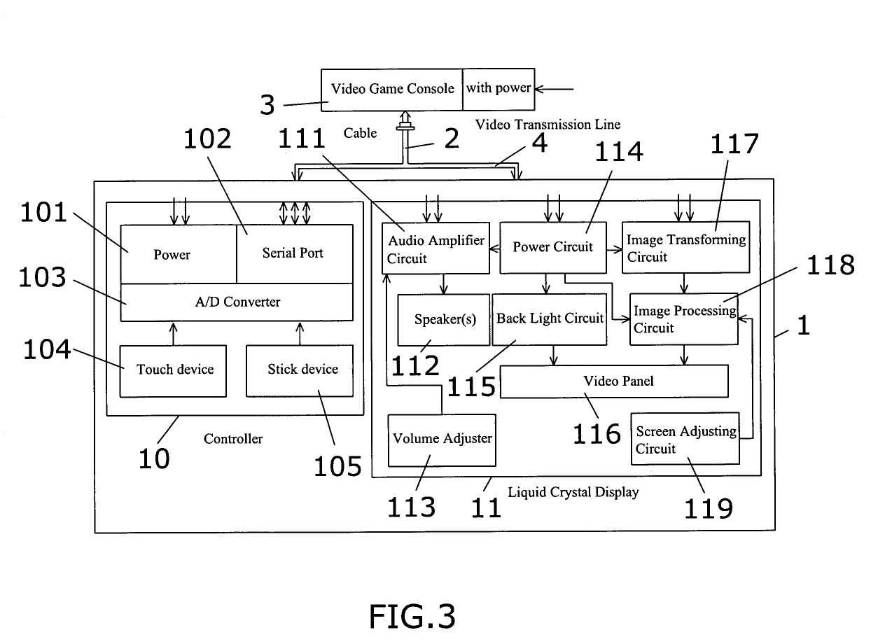

Referring to the FIGS. 2 and 3, the controller 10 comprises a power 101, a serial port 102, an A/D converter 103, a touch device 104, and a stick device 105 which are connecting mutually. The touch device 104 includes several function keys and the stick device 105 includes at least one mini-stick, which are deployed on the proper positions of the joypad 1 panel by considering the playing convenience of the user's hands.

And the liquid crystal display 11 comprises an audio amplifier 111, a set of speaker(s) 112, a volume adjuster 113, a power circuit 114, a back light circuit 115, a video panel 116, an image transforming circuit 117, an image processing circuit 118, a screen adjusting circuit 119 which are connecting mutually. The set of speaker(s) 112 is deployed on the proper positions of the joypad 1 such as the opposite lateral sides or the symmetric position near the edges on the joypad 1 front panel for enhancing the entertainment effects and the live feelings. The volume adjuster 113 is set on the front panel of the joypad 1 for enhancing the user's convenience to adjust the volume anytime as required during game playing. The back light circuit 115 is used to provide the auxiliary illuminants. And the video panel 116 is set on the center of the joypad 1 panel and is used to present the whole images of the game smoothly.

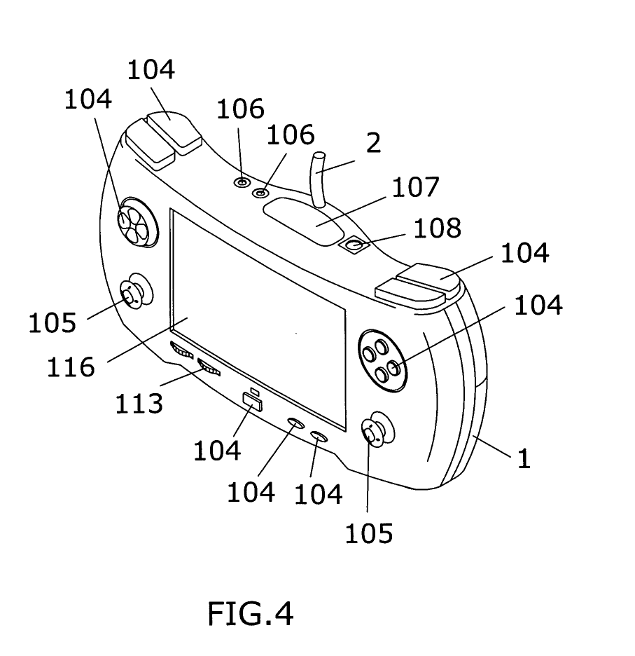

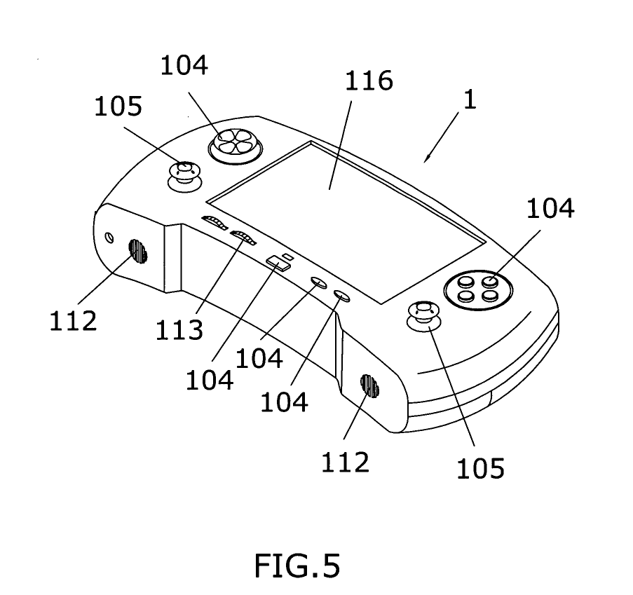

Referring to the FIGS. 4 and 5, there is a set of corresponding function keys which is deployed on the front panel near the both lateral edges of the joypad 1 used to control the game by the user's left and right hands separately. On one lateral side of the joypad 1, there are an AV connecter 106 for connecting and receiving the video signal of the video game console 3, a memory card hub 107 with at least one slot for sticking at least one memory card each, and a jack 108 for connecting an external AC power to charge the battery or to supply the electric power anytime.

According to the joypad 1 structure mentioned above, the cable 2 and the video transmission line 4 connect the joypad 1 and the video game console 3 together. As any of the function key of the touch device 104 is pressed, the changed electric signals is transmitted through the cable 2 to the video game console 3 for calculating and deciding how to control or to present the effects. And the audio and video electric signals of the video game console 3 is transmitted to the audio amplifier circuit 111 and the image transmission circuit 117 through the video transmission line 4 and is transferred to the bright and dazzling sound and light effects. Through the game playing process, the complete smooth images of the whole game are present on the video panel 116. And the touch device 104 and the stick device 105 deployed on the front panel of the joypad 1 can perform different functions on different games, which are defined by each game's commands. As facing the changing scenario, the user can choose the proper function as required based on the arranged plots to eliminate the obstacles for gaining the high score then passing the critical test to enter the next stage or to retry the current stage.

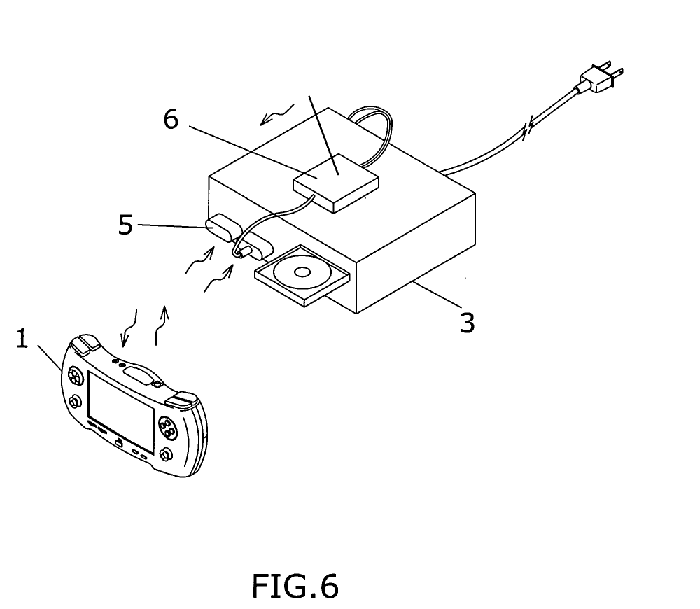

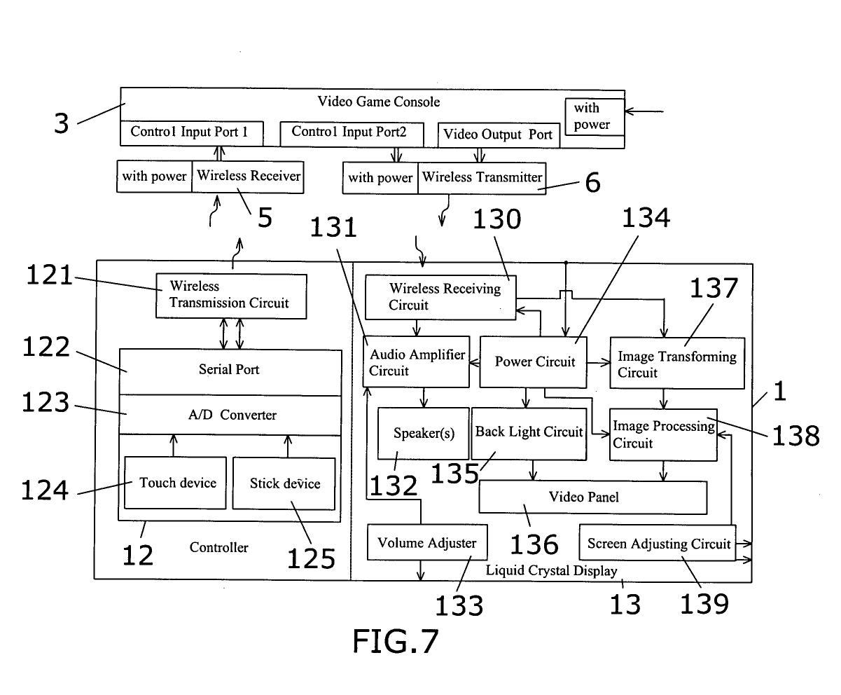

Referring to the FIGS. 6 and 7, it is a wireless connection embodiment of the video game console 3. This wireless connection structure comprises the video game console 3, the joypad 1, the wireless receiver 5, and the wireless transmitter 6. And the video game console 3 includes a jack to connect an external AC power, a control input port to connect the wireless receiver 5, as well as another control input port and a video output port to connect the wireless transmitter 6.

The joypad 1 comprises the combination of a controller 12 and a liquid crystal display 13 together for commanding the video game and for displaying the game images. The controller 12 comprises a wireless transmission circuit 121, a serial port 122, an A/D converter 123, a touch device 124, and a stick device 125 which are connecting mutually. The control signals wireless transmission circuit 121 changes and transfers the electric signals to the wireless receiver 5 in the video game console 3. And the touch device 124 includes several function keys and the stick device 125 includes at least one mini-stick, which are deployed on the proper positions of the joypad 1 panel by considering the playing convenience of the user's hands.

And the liquid crystal display 13 comprises a wireless receiving circuit 130, an audio amplifier circuit 131, a set of speaker(s) 132, a volume adjuster 133, a power circuit 134, a back light circuit 135, a video panel 136, an image transforming circuit 137, an image processing circuit 138, a screen adjusting circuit 139 which are connecting mutually. The wireless receiving circuit 130 is used to receive the video and audio signals emitted from the wireless transmitter 6 in the video game console 3. The set of speaker(s) 132 is deployed on the proper positions of the joypad 1 such as the opposite lateral sides or the symmetric position near the edges on the joypad 1 front panel for enhancing the entertainment effects and the live feelings. The volume adjuster 133 is set on the front panel of the joypad 1 for enhancing the user's convenience to adjust the volume anytime as required during game playing. The back light circuit 135 is used to provide the auxiliary illuminants. And the video panel 136 is set on the center of the joypad 1 panel and is used to present the whole images of the game smoothly.

Furthermore, there is a set of corresponding function keys of the touch device 124 which is deployed on the front panel near the both lateral edges of the joypad 1 used to control the game by the user's left and right hands separately. The wireless transmission circuit 121 of the control signals and the wireless receiving circuit 130 of the video and audio signals are set on the central front side of the joypad 1 to convey all kinds of signals with the video game console 3 mutually. Also on one lateral side of the joypad 1, there are a memory card hub 107 with at least one slot for sticking at least one memory card each, and a jack 108 for connecting an external AC power to charge the battery or to supply the electric power anytime.

According to the mentioned above wireless structure, the video game console 3 transmits the video signals to the wireless receiving circuit 130 set in the joypad 1 through the wireless transmitter 6 to allow the video panel 136 showing the bright and dazzling effects. In the mean time, the joypad 1 can transmit the changed control signals through the wireless transmission circuit 121 to the wireless receiver 5 set in the video game console 3 for controlling the objects' reaction in game.

Through the game playing process, the complete smooth images of the whole game are present on the video panel 136. And the touch device 124 and the stick device 125 deployed on the front panel of the joypad 1 can perform different functions on different games, which are defined by each game's commands. As facing the changing scenario, the user can choose the proper function as required based on the arranged plots to eliminate the obstacles for gaining the high score then passing the critical test to enter the next stage or to retry the current stage.

Because this video game console 3 structure can combine the present normally used game controller and home television together to form a joypad 1 with a liquid crystal display 11 and 13. Collocating with the operations of the wire or wireless signals transmission mode, the joypad 1 could allow the user to eliminate the playing space limitation such as indoor terrain and features, or to avoid the impacts such as the installation position of the video game console 3 or the temporary interference from outside to enhance the flexibility. Especially, in the wireless transmission effective range, the user could carry the joypad 1 to play without other interference. And this invention really improves the user's enjoyable feeling by reducing to interrupt the game by any reason.

Furthermore, the joypad 1 combined a liquid crystal display 11 and 13 with wire or wireless connection structure can use the power supplied by not only the video game console 3 but also the external AC power or the DC batteries. So the jack 108 is set on the joypad 1 for connecting the AC power, or a chamber in the joypad 1 for connecting the DC batteries. Similarly, the wireless transmitter 6 can be pre-charged for avoiding the inconvenience caused by the power off situation. Therefore, one of the original features of this invention is to use the power supplied from the video game console 3, the external AC power or the DC batteries.

This invention has been proof to work through tests and meets the requirements of the patent application.

Obviously the invention is susceptible to changes or alternations without defeating its practicability. Therefore, the preferred embodiments shown in the drawings and described herein are not confined.

What is claimed are:

1. A joypad with a display unit comprising:
a controller for game commands controlling and screen displaying;
said controller connecting a power, a serial port, an A/D converter, a touch device and a stick device mutually;
a liquid crystal display to show the game images;
said liquid crystal display connecting an audio amplifier circuit, a set of speaker, a volume adjuster, a power circuit, a back light circuit, a video panel, an image transforming circuit, an image processing circuit, and a screen adjusting circuit mutually;
a cable for connecting said controller with a video game console to transmit the electric signals;
a video transmission line for connecting said liquid crystal display to said video game console to transmit the video signals shown on said liquid crystal display.

2. The joypad with a display unit according to claim 1 and further including:
an AV connector for receiving video signals.

3. The joypad with a display unit according to claim 1 and further including:
a memory card hub for plugging a memory card each.

4. The joypad with a display unit according to claim 1 and further including:
a jack for connecting an external AC power.

5. The joypad with a display unit according to claim 1 and further including:
a chamber for installing batteries.

6. A joypad with a display unit comprising:
a controller for game commands controlling and screen displaying;
said controller connecting a power, a serial port, an A/D converter, a touch device and a stick device mutually;
a liquid crystal display to show the game images;
said liquid crystal display connecting an audio amplifier circuit, the speaker(s), the volume adjuster, a power circuit, a back light circuit, a video panel, an image transforming circuit, an image processing circuit, and a screen adjusting circuit mutually;
a wireless transmitter circuit for transmit the electric signals to a video game console;
a wireless receiver circuit for receiving the video signals from said video game console.

7. The joypad with a display unit according to claim 6 and further including:
a wireless receiver and a wireless transmitter being concluded in said video game console.

8. The joypad with a display unit according to claim 6 and further including:
a memory card hub for plugging a memory card each.

9. The joypad with a display unit according to claim 6 and further including:
a jack for connecting an external AC power.

10. The joypad with a display unit according to claim 6 and further including:
a chamber for installing batteries.
